(19) United States
(12) Patent Application Publication
(10) Pub. No.: US 2022/0212922 A1
(43) Pub. Date: Jul. 7, 2022

(54) Method for Manufacturing Hydrogen Microbubbles and Device Thereof

(71) Applicant: Season Farm Technology Co., Ltd., Tainan City (TW)

(72) Inventor: Ching-Chieh Yang, Kaohsiung City (TW)

(21) Appl. No.: 17/610,793

(22) PCT Filed: May 24, 2019
(86) PCT No.: PCT/CN2019/088239

§ 371 Date: Nov. 12, 2021

(51) Int. Cl. C01B 3/08; C02F 1/68; B01F 23/231; B01J 7/02; C01F 5/02

(52) U.S. Cl. CPC C01B 3/08; C02F 1/68; B01F 2101/305; B01J 7/02; C01F 5/02; B01F 23/23121

(57) ABSTRACT

Disclosed are a method for manufacturing hydrogen microbubbles (A1) and a device (10) thereof. The device comprises air pressure assembly (1) and a water container (2), wherein the water container (2) is loaded with water (A). The air pressure assembly (1) can perform gas suction and pressurization and the gas enters a hydrogen oscillation generation unit (3). The hydrogen oscillation generation unit (3) is internally provided with a magnesium alloy-manufactured hydrogen oscillator (4), and the hydrogen oscillator (4) is reacted with water molecules contained in the gas to obtain magnesium oxide and hydrogen. Then, the chemically reacted gas is sprayed by the hydrogen oscillation generation unit (3) into the water (A) via a gas spray nozzle (5), forming hydrogen microbubbles (A1) containing hydrogen in the water (A).

### TECHNICAL FIELD

The present application relates to a technical field of hydrogen microbubbles and, more particularly, to a method for manufacturing hydrogen microbubbles and the device thereof.

### BACKGROUND TECHNOLOGY

Nowadays, it is known that microbubbles are added in the water and available for agriculture, irrigation, fishery, farming, food processing, and industrial cleanup, the diameter of the microbubbles in the water is usually about 50 micrometer, to form a visual effect of emulsification in the water, and the microbubbles can stay in the water during a longer time. Afterwards, application of the microbubbles, initially increases the dissolved oxygen content in the aquarium required for farming of ornamental fishes, then gradually applies the technology to agriculture, irrigation, fishery, farming, food processing, and industrial cleanup, the method utilizes air bottles of high cost to individually cast a gas, such as hydrogen, oxygen, nitrogen, carbon dioxide, and ozone, using the unique property of various gases, to execute different kinds of work according to the targets, but, in application of the microbubbles, except the oxygen, the hydrogen microbubbles are particularly outstanding in use, the feature of the hydrogen microbubbles is in that, the hydrogen in the microbubbles produces a micro-range high temperature blast during the instantaneous cracking process, various organic mixtures in the water, including microbes, virus, bacteria or pollutants, are burned, cleared, and diminished by the micro-range high temperature blast, thereby achieving the purpose of purifying the water quality physically.

Further, in order to prevent use of individual hydrogen air bottles with high cost, the market is turned to use an electrolyzer for applying the hydrogen microbubbles in the water, in application of the electrolyzer, it uses an electric power for discharging to decompose water molecules contained in the air into hydrogen and oxygen, the hydrogen and oxygen are pressurized to enter the water to form microbubbles, wherein the hydrogen microbubbles are soaked in the water to cause a micro-range high temperature blast.

However, it is necessary to provide a large amount of electric power to the conventional electrolyzer, so as to be able to decompose the water molecules into hydrogen and oxygen, and the electrolyzer has to stop operating for maintenance and replacement so as to keep the normal operating efficiency, so that the cost of the electrolyzer is very high, and the electrolyzer cannot attract the consumers, thereby affecting the popularity and acceptance of the electrolyzer.

### CONTENT OF THE INVENTION

The objective of the present application is to provide a method for manufacturing hydrogen microbubbles and the device thereof, using hydrogen oscillators made of a magnesium alloy to apply a chemical reaction to the water molecules contained in the gas to form hydrogen, thereby reducing the cost for making the hydrogen.

A method for manufacturing hydrogen microbubbles of the present application, at least comprises an air pressurizing assembly, and at least comprises a water container, the manufacturing method comprises the steps:

step a, the water container contains water;

step b, the air pressurizing assembly sucks and pressurizes a gas to enter at least a hydrogen oscillation generating unit, the hydrogen oscillation generating unit has an interior distributed with hydrogen oscillators made of a magnesium alloy, the hydrogen oscillators chemically reacts with water molecules contained in the gas to form magnesium oxide and hydrogen;

step c, the hydrogen oscillation generating unit drives the gas after the chemical reaction to pass a gas nozzle head which injects the gas into the water, and the gas nozzle head is at least provided with a micro-gas spray orifice, the gas after oscillation passes the micro-gas spray orifice and is injected into the water to form hydrogen microbubbles which contains hydrogen.

A hydrogen microbubbles device of the present application at least comprises an air pressurizing assembly, the air pressurizing assembly at least includes an air inlet terminal and an air outlet terminal, one side of the air inlet terminal is at least connected with an air inlet unit, the air inlet unit is at least provided with an air inlet hole penetrating the air inlet terminal, then, the air outlet terminal is at least connected with a hydrogen oscillation generating unit, the hydrogen oscillation generating unit has an interior provided with a receiving chamber connected to the air outlet terminal, the receiving chamber has an interior distributed and provided with hydrogen oscillators made of a magnesium alloy, and the other side of the hydrogen oscillation generating unit is at least connected with an air outlet pipe connected to the receiving chamber, the air outlet pipe has a left end at least connected with a gas nozzle head, the gas nozzle head is at least penetrated with a micro-gas spray orifice connected to the air outlet pipe.

The air inlet hole of the present application has a side at least connected with a venturi tube, the venturi tube is provided with a venturi tube hole connected to the air inlet hole, the venturi tube has an upper portion further provided with a flow control valve controlling a diameter of the venturi tube hole, the venturi tube has a side connected with a filter connecting pipe, the filter connecting pipe has a side provided with a socket mounting portion, the socket mounting portion is secured with an air inlet filter.

The air inlet hole of the present application has a side at least connected with a filter connecting pipe, the filter connecting pipe has a side provided with a socket mounting portion, the socket mounting portion has an outer edge further provided with an outer threaded section, the socket mounting portion is further provided with a socket which is recessed toward the other side thereof and is connected to the filter connecting pipe, the socket is at least further provided with a stop filtering plate which is inserted into and rests on the other side of the socket, and is further provided with an air inlet filter which presses the stop filtering plate, the other side of the air inlet filter has a periphery further provided with a press ring which cooperates with the socket to press and fix the stop filtering plate, the press ring has a center provided with a filter column protruding rightward, the air inlet filter is further provided with a filter chamber which is recessed from left to right, the filter chamber is filled with a primary filter element, the primary filter element is restricted in the filter chamber by the stop filtering plate, afterwards, a filter pressing ring is rotatably connected with the outer threaded section, the filter pressing ring is further provided with an inner threaded section engaging the outer threaded section, and the filter pressing ring has a right end further provided with a pressing ring resting portion pressing the press ring.

The air outlet pipe of the present application has a left end at least connected with a nozzle head socket mounting portion, the nozzle head socket mounting portion has an outer edge further provided with a mounting portion outer threaded section, the nozzle head socket mounting portion is further provided with a nozzle head socket which is recessed toward one side thereof and is connected to the air outlet pipe, a gas nozzle head is inserted into the nozzle head socket, one side of the gas nozzle head has a periphery further provided with a nozzle head press ring inserted into the nozzle head socket, the nozzle head press ring has a center provided with a nozzle head column protruding leftward, the nozzle head column is at least penetrated with a micro-gas spray orifice connected to the air outlet pipe, a nozzle head socket pressing ring is rotatably connected with the mounting portion outer threaded section, the nozzle head socket pressing ring is further provided with a nozzle head socket pressing ring inner threaded section engaging the mounting portion outer threaded section, and the nozzle head socket pressing ring has a left end further provided with a nozzle head socket pressing ring resting portion pressing the nozzle head press ring.

In the present application, the price of the hydrogen oscillators made of a magnesium alloy is not high, is available for mass application, and the water molecules contained in the gas do not have the problem of cost, so the cost for performing oscillation to form and separate into oxygen and hydrogen is only limited to that of replacement of the hydrogen oscillators, so the operating cost of the hydrogen microbubbles device is very low.

### DESCRIPTION OF THE APPENDED DRAWINGS

FIG. 1 is a schematic view of a hydrogen microbubbles device of the present application.

FIG. 2 is an enlarged schematic view of an air inlet filter of the present application.

FIG. 3 is an enlarged schematic view of a gas nozzle head of the present application.

In the drawings:

A water; A1 hydrogen microbubbles; 10 hydrogen microbubbles device; 1 air pressurizing assembly; 11 air inlet terminal; 12 air outlet terminal; 13 air inlet unit; 131 air inlet hole; 14 venturi tube; 141 venturi tube hole; 15 flow control valve; 16 filter connecting pipe; 161 socket mounting portion; 162 outer threaded section; 163 socket; 164 stop filtering plate; 165 air inlet filter;

166 press ring; 167 filter column; 168 filter chamber; 169 primary filter element; 17 filter pressing ring; 171 inner threaded section; 172 pressing ring resting portion; 2 water container; 3 hydrogen oscillation generating unit; 31 receiving chamber; 32 air outlet pipe; 33 nozzle head socket mounting portion; 331 mounting portion outer threaded section; 332 nozzle head socket; 4 hydrogen oscillators; 34 nozzle head socket pressing ring; 341 nozzle head socket pressing ring inner threaded section; 342 nozzle head socket pressing ring resting portion; 4 hydrogen oscillators; 5 gas nozzle head; 51 gas spray orifice; 52 nozzle head press ring; 53 nozzle head column.

### DETAILED EMBODIMENT

The drawings and the embodiments are associated below to further illustrate the present application, so that the skilled person in this field can better understand and practice the present application, but the examples will not limit the present application.

The present application primarily provides a method for manufacturing hydrogen microbubbles, at least comprises an air pressurizing assembly 1, and at least comprises a water container 2.

The manufacturing method has the steps:

step a, the water container 2 contains water A;

step b, the air pressurizing assembly 1 sucks and pressurizes a gas to at least enter a hydrogen oscillation generating unit 3, the hydrogen oscillation generating unit 3 has an interior distributed with hydrogen oscillators 4 made of a magnesium alloy with high activity, the hydrogen oscillators 4 apply a chemical reaction to water molecules contained in the gas to form magnesium oxide and hydrogen, wherein, oxygen in the water molecules chemically reacts with the magnesium alloy to form the magnesium oxide and release the hydrogen;

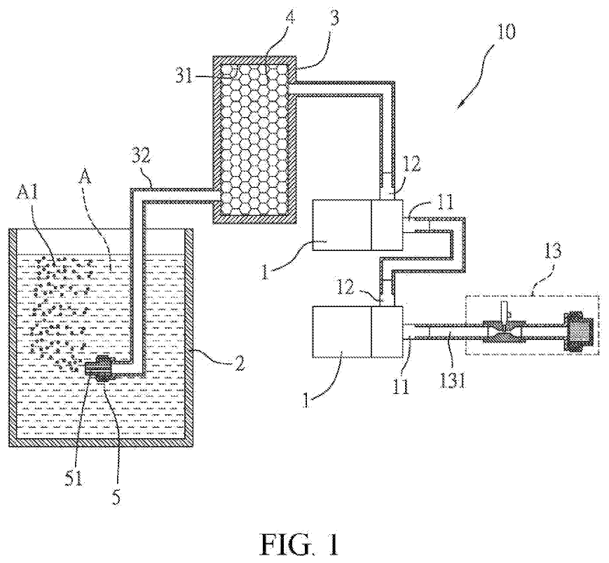

step c, the hydrogen oscillation generating unit 3 drives the gas after the chemical reaction to pass a gas nozzle head 5 which injects the gas into the water A, and the gas nozzle head 5 is at least provided with a micro-gas spray orifice 51 penetrating therethrough, the gas after oscillation passes the micro-gas spray orifice 51 and is injected into the water A to form hydrogen microbubbles A1 which contains hydrogen with a high hydrogen content (for example: as shown FIG. 1).

A hydrogen microbubbles device 10 of the present application at least comprises an air pressurizing assembly 1, the air pressurizing assembly 1 at least includes an air inlet terminal 11 and an air outlet terminal 12, one side of the air inlet terminal 11 is at least connected with an air inlet unit 13, the air inlet unit 13 is at least provided with an air inlet hole 131 penetrating the air inlet terminal 11, then, the air outlet terminal 12 is at least connected with a hydrogen oscillation generating unit 3, the hydrogen oscillation generating unit 3 has an interior provided with a receiving chamber 31 connected to the air outlet terminal 12, the receiving chamber 31 has an interior distributed and provided with hydrogen oscillators 4 made of a magnesium alloy, and the other side of the hydrogen oscillation generating unit 3 is at least connected with an air outlet pipe 32 connected to the receiving chamber 31, the air outlet pipe 32 has a left end at least connected with a gas nozzle head 5, the gas nozzle head 5 is at least penetrated with a micro-gas spray orifice 51 connected to the air outlet pipe 32 (as shown FIG. 1).

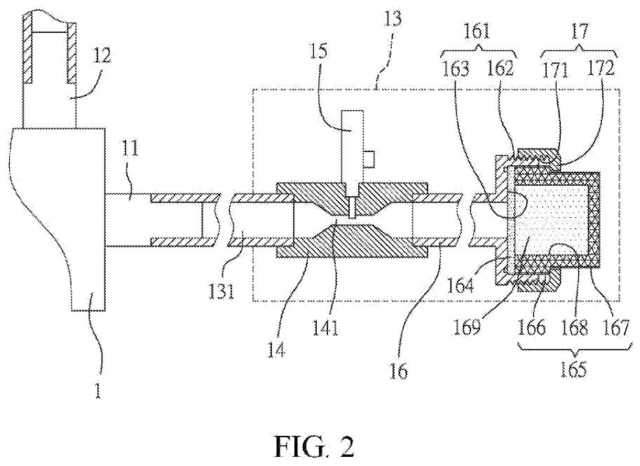

The air inlet hole 131 of the present application has a side at least connected with a venturi tube 14 which contains the previously oscillated gas which contains water molecules, the venturi tube 14 is provided with a venturi tube hole 141 connected to the air inlet hole 131, in addition, the venturi tube 14 has an upper portion further provided with a flow control valve 15 controlling a diameter of the venturi tube hole 141, the venturi tube 14 has a side connected with a filter connecting pipe 16, the filter connecting pipe 16 has a side provided with a socket mounting portion 161, the socket mounting portion 161 has an outer edge further provided with an outer threaded section 162, the socket mounting portion 161 is further provided with a socket 163 which is recessed toward the other side thereof and is connected to the filter connecting pipe 16, the socket 163 is at least further provided with a stop filtering plate 164 which is inserted into and rests on the other side of the socket 163, and is further provided with an air inlet filter 165 which presses the stop filtering plate 164, the other side of the air inlet filter 164 has a periphery further provided with a press ring 166 which cooperates with the socket 163 to press and fix the stop filtering plate 164, the press ring 166 has a center provided with a filter column 167 protruding rightward, the air inlet filter 167 is further provided with a filter chamber 168 which is recessed from left to right, the filter chamber 168 is filled with a primary filter element 169, the primary filter element 169 is restricted in the filter chamber 168 by the stop filtering plate 164, afterwards, a filter pressing ring 17 is rotatably connected with the outer threaded section 162, the filter pressing ring 17 is further provided with an inner threaded section 171 engaging the outer threaded section 162, and the filter pressing ring 17 has a right end further provided with a pressing ring resting portion 172 pressing the press ring 166 (as shown FIG. 2).

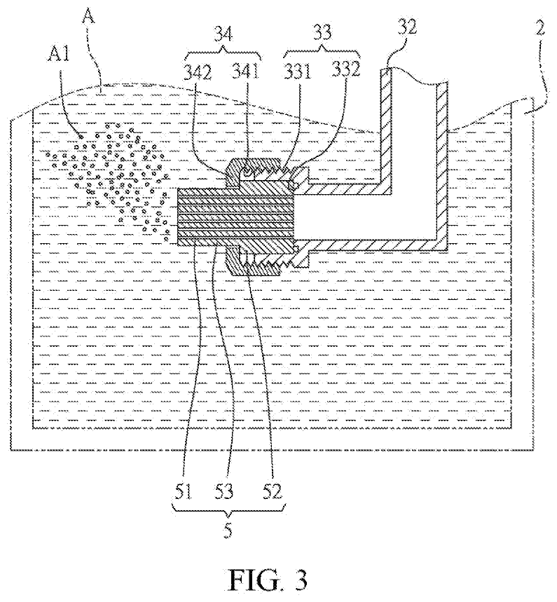

The air outlet pipe 32 of the present application has a left end at least connected with a nozzle head socket mounting portion 33, the nozzle head socket mounting portion 33 has an outer edge further provided with a mounting portion outer threaded section 331, the nozzle head socket mounting portion 33 is further provided with a nozzle head socket 332 which is recessed toward one side thereof and is connected to the air outlet pipe 32, a gas nozzle head 5 is inserted into the nozzle head socket 332, one side of the gas nozzle head 5 has a periphery further provided with a nozzle head press ring 52 inserted into the nozzle head socket 332, the nozzle head press ring 52 has a center provided with a nozzle head column 53 protruding leftward, the nozzle head column 53 is at least penetrated with a micro-gas spray orifice 51 connected to the air outlet pipe 32, a nozzle head socket pressing ring 34 is rotatably connected with the mounting portion outer threaded section 331, the nozzle head socket pressing ring 34 is further provided with a nozzle head socket pressing ring inner threaded section 341 engaging the mounting portion outer threaded section 331, and the nozzle head socket pressing ring 34 has a left end further provided with a nozzle head socket pressing ring resting portion 342 pressing the nozzle head press ring 52 (as shown FIG. 3).

The hydrogen oscillators 4 of the present application are made of a magnesium alloy in the hydrogen oscillation generating unit 3, the hydrogen oscillators 4 apply a chemical reaction to the water molecules contained in the gas to form magnesium oxide and hydrogen, then, the hydrogen oscillation generating unit 3 drives the gas after the chemical reaction to pass the gas nozzle head 5 which injects the gas into the water A, so that the water A contains the hydrogen microbubbles A1 with a high hydrogen content. The price of the hydrogen oscillators 4 made of a magnesium alloy is not high, is available for mass application, and the water molecules contained in the gas do not have the problem of cost, so the cost for performing a chemical reaction to form magnesium oxide and hydrogen is only limited to that of replacement of the hydrogen oscillators 4, so the operating cost of the hydrogen microbubbles device 10 is reduced to the minimum which is the advantage thereof.

The abovementioned embodiment is only a preferred embodiment that fully illustrates the present application, the protected range of the present application is not limited to it. The replacement or change made by a skilled person in this field on the basis of the present application will fall within the protected scope of the present application. The protected scope of the present application is based on the claims

### INDUSTRIAL APPLICABILITY

A method for manufacturing hydrogen microbubbles and the device thereof provided by the embodiment of the present application are in that, the price of the hydrogen oscillators made of a magnesium alloy is not high, is available for mass application, and the water molecules contained in the gas do not have the problem of cost, so the cost for performing oscillation to form and separate into oxygen and hydrogen is only limited to that of replacement of the hydrogen oscillators, so the operating cost of the hydrogen microbubbles device is very low. Thus, there is industrial applicability.

1. A method for manufacturing hydrogen microbubbles, wherein, at least comprising an air pressurizing assembly, and at least comprising a water container, the manufacturing method comprising the steps:
step a, the water container contains water;
step b, the air pressurizing assembly sucks and pressurizes a gas to enter at least a hydrogen oscillation generating unit, the hydrogen oscillation generating unit has an interior distributed with hydrogen oscillators made of a magnesium alloy, the hydrogen oscillators chemically reacts with water molecules contained in the gas to form magnesium oxide and hydrogen;
step c, the hydrogen oscillation generating unit drives the gas after the chemical reaction to pass a gas nozzle head which injects the gas into the water, and the gas nozzle head is at least provided with a micro-gas spray orifice, the gas after oscillation passes the micro-gas spray orifice and is injected into the water to form hydrogen microbubbles which contains hydrogen.

2. A hydrogen microbubbles device, wherein, at least comprises an air pressurizing assembly, the air pressurizing assembly at least includes an air inlet terminal and an air outlet terminal, one side of the air inlet terminal is at least connected with an air inlet unit, the air inlet unit is at least provided with an air inlet hole penetrating the air inlet terminal, then, the air outlet terminal is at least connected with a hydrogen oscillation generating unit, the hydrogen oscillation generating unit has an interior provided with a receiving chamber connected to the air outlet terminal, the receiving chamber has an interior distributed and provided with hydrogen oscillators made of a magnesium alloy, and the other side of the hydrogen oscillation generating unit is at least connected with an air outlet pipe connected to the receiving chamber, the air outlet pipe has a left end at least connected with a gas nozzle head, the gas nozzle head is at least penetrated with a micro-gas spray orifice connected to the air outlet pipe.

3. The hydrogen microbubbles device as said in claim 2, wherein the air inlet hole has a side at least connected with a venturi tube, the venturi tube is provided with a venturi tube hole connected to the air inlet hole, the venturi tube has an upper portion further provided with a flow control valve controlling a diameter of the venturi tube hole, the venturi tube has a side connected with a filter connecting pipe, the filter connecting pipe has a side provided with a socket mounting portion, the socket mounting portion is secured with an air inlet filter.

4. The hydrogen microbubbles device as said in claim 2, wherein the air inlet hole has a side at least connected with a filter connecting pipe, the filter connecting pipe has a side provided with a socket mounting portion, the socket mounting portion has an outer edge further provided with an outer threaded section, the socket mounting portion is further provided with a socket which is recessed toward the other side thereof and is connected to the filter connecting pipe, the socket is at least further provided with a stop filtering plate which is inserted into and rests on the other side of the socket, and is further provided with an air inlet filter which presses the stop filtering plate, the other side of the air inlet filter has a periphery further provided with a press ring which cooperates with the socket to press and fix the stop filtering plate, the press ring has a center provided with a filter column protruding rightward, the air inlet filter is further provided with a filter chamber which is recessed from left to right, the filter chamber is filled with a primary filter element, the primary filter element is restricted in the filter chamber by the stop filtering plate, afterwards, a filter pressing ring is rotatably connected with the outer threaded section, the filter pressing ring is further provided with an inner threaded section engaging the outer threaded section, and the filter pressing ring has a right end further provided with a pressing ring resting portion pressing the press ring.

5. The hydrogen microbubbles device as said in claim 2, wherein the air outlet pipe has a left end at least connected with a nozzle head socket mounting portion, the nozzle head socket mounting portion has an outer edge further provided with a mounting portion outer threaded section, the nozzle head socket mounting portion is further provided with a nozzle head socket which is recessed toward one side thereof and is connected to the air outlet pipe, a gas nozzle head is inserted into the nozzle head socket, one side of the gas nozzle head has a periphery further provided with a nozzle head press ring inserted into the nozzle head socket, the nozzle head press ring has a center provided with a nozzle head column protruding leftward, the nozzle head column is at least penetrated with a micro-gas spray orifice connected to the air outlet pipe, a nozzle head socket pressing ring is rotatably connected with the mounting portion outer threaded section, the nozzle head socket pressing ring is further provided with a nozzle head socket pressing ring inner threaded section engaging the mounting portion outer threaded section, and the nozzle head socket pressing ring has a left end further provided with a nozzle head socket pressing ring resting portion pressing the nozzle head press ring.
